(19) United States
(12) Patent Application Publication
(10) Pub. No.: US 2016/0171159 A1
(43) Pub. Date: Jun. 16, 2016

(54) OPTICAL RECOGNITION OF BLOOD TYPES

(71) Applicant: ORIG3N Inc., Boston, MA (US)

(72) Inventor: Robin Y. Smith, Boston, MA (US)

(21) Appl. No.: 14/970,822

(22) Filed: Dec. 16, 2015

Related U.S. Application Data
(63) Continuation of application No. 62/092,332, filed on Dec. 16, 2014.

(51) Int. Cl. G06F 19/00; G06K 9/00; H04N 5/44; G06T 7/00

(52) U.S. Cl. CPC G06F 19/321; G06T 7/0012; G06K 9/00442; H04N 5/44

(57) ABSTRACT

Disclosed are methods for analyzing blood and displaying information related to blood type. A method may be a computer-implemented method or utilize computer-implemented steps. Some aspects of the invention relate to a system for analyzing blood, comprising a computer, wherein the computer is configured to identify a blood type. The computer may be, for example, a tablet computer or smartphone.

### PRIORITY

This application claims priority to U.S. Provisional Patent Application No. 62/092,332, filed Dec. 16, 2014.

### BACKGROUND

Blood typing is the identification of antigens on the surface of red blood cells (e.g., “A-antigens,” “B-antigens,” and/or Rh factor). Blood type is inherited from and dependent upon the blood type of one's parents. In the case of a transfusion, a blood donor's blood type is preferentially compatible with the recipient's blood type, or an acute hemolytic reaction may occur. Many commercial blood typing kits comprise a blood typing card, such as an ELDONCARD™, which was first developed in the 1950s. Such kits require a user to interpret coagulation patterns on the card and thereby determine blood type. Improved methods for determining blood type remain desirable.

### SUMMARY

Aspects of the invention relate to methods for analyzing blood and displaying information related to blood type. A method may be a computer-implemented method or utilize computer-implemented steps. Some aspects of the invention relate to a system for analyzing blood, comprising a computer, wherein the computer is configured to identify a blood type. The computer may be, for example, a tablet computer or smartphone.

### BRIEF DESCRIPTION OF THE DRAWINGS

FIG. 1 depicts a system for analyzing blood, comprising a camera, a computer, and a display. The camera and display are the camera and display of a tablet computer or smartphone (middle image, stating “A-Positive”). The camera is configured to obtain a first image. In this case, the first image is the image of a test card (upper right). The computer and camera are connected by a wireless connection interface through a wireless network (such as Wi-Fi or a cellular network). The computer (upper left) is configured to receive the first image, determine whether the first image comprises information related to a blood type, if so, identify the blood type, and send blood-type content to the tablet computer or smartphone. The tablet computer or smartphone is configured to display a second image comprising the blood-type content and an image of the test card.

FIG. 2 is a flow chart that depicts a method for constructing a second image, wherein the second image comprises a real-time image (“Video Image”) and content (“Portion of Augmentation Data”). A “Graphical Representation” may be, for example, a graphical representation of a test card. The presentation of a real-time image and content on a display may be adjusted, for example, based on the orientation of a display (“Device Orientation”) or based on received “User Input.”

FIG. 3 depicts a system for analyzing blood, comprising a camera, a computer, and a display. The camera and display are the camera and display of a tablet computer or smartphone (middle image). The camera is configured to obtain a first image. In this case, the first image is the image of a test card (upper right). The computer and camera are connected by a wireless connection interface through a wireless network (such as Wi-Fi or a cellular network). The computer (upper left) is configured to receive the first image, determine whether the first image comprises information related to a blood type, if so, identify the blood type, and send location content to the tablet computer or smartphone identifying the location of blood, blood plasma, and/or donors and/or recipients thereof. The tablet computer or smartphone is configured to display a second image comprising the location content and a map.

FIG. 4 depicts a display of a tablet-computer or smartphone, displaying a second image comprising blood-type content and location content.

### DETAILED DESCRIPTION

### I. Method Overview

In some aspects, the invention relates to a method for analyzing blood. The method may be a computer-implemented method, or the method may comprise one or more computer-implemented steps. The method may comprise one or more steps that are not computer-implemented, such as contacting a test card with blood or a component thereof.

Analyzing blood may refer to analyzing whole blood or analyzing a component of blood, such as erythrocytes. Analyzing blood may comprise analyzing a nucleic acid, such as DNA or RNA. The nucleic acid may or may not be obtained from blood, so long as analyzing the nucleic acid comprises analyzing at least one feature that is associated with blood, such as blood type.

Analyzing blood may refer to obtaining information about blood, e.g., about the blood of a subject. A blood type may be a human leukocyte antigen (HLA) type.

A method may comprise obtaining a first image. A method may comprise determining whether a first image comprises information related to a blood type. Determining whether a first image comprises information related to a blood type may comprise determining whether a first image comprises an image of a test card (e.g., a blood test card). A method may comprise identifying a blood type, e.g., if the first image comprises information related to a blood type. A method may comprise displaying a second image, e.g., if the first image comprises information related to a blood type.

### II. Test Cards

A first image may comprise an image of a test card. A test card may be a blood test card, such as an ELDONCARD™. A method may comprise obtaining an image of a test card, e.g., wherein the image is the first image. Test cards are known (see, e.g., U.S. Pat. No. 2,770,572, hereby incorporated by reference).

A test card may comprise one or more antibodies selected from the group consisting of an anti-A antibody, an anti-B antibody, and an anti-Rh antibody. An anti-A antibody may be an antibody that specifically binds to the blood group A antigen. An anti-B antibody may be an antibody that specifically binds to the blood group B antigen. An anti-Rh antibody may be an antibody that specifically binds to Rh factor. A test card may comprise an anti-A antibody, an anti-B antibody, and an anti-Rh antibody. A test card may comprise at least one antibody that specifically binds to an antigen selected from the group consisting of A₁, A₂, B, O, D, C, E, c, e, M, N, S, s, P1, Lea, Le^{b}, K, k, Js^{a} Fy^{a}, Fy^{b}, Jk^{a}, Jk^{b}, Lu^{a}, and Lu^{b}.

A method may comprise identifying an A antigen, B, antigen, Rh factor, and/or the lack of at least one of the foregoing. A method may comprise identifying an antigen selected from the group consisting of A₁, A₂, B, O, D, C, E, c, e, M, N, S, s, P1, Lea, Le^{b}, K, k, Js^{a}, Fy^{a}, Fy^{b}, Jk^{a}, Jk^{b}, Lu^{a}, and Lu^{b}, and/or the lack of at least one of the foregoing.

A test card may comprise a control antibody. A control antibody may specifically bind to a protein, wherein the protein is not present in blood cells. A control antibody may specifically bind to a protein, wherein the protein is not present in the membrane of a blood cell. A control antibody may specifically bind to a protein on a blood cell, such as an erythrocyte. A control antibody may specifically bind to a protein on a platelet. A method may comprise identifying a control antigen or the lack of a control antigen, e.g., on blood or a blood component.

A test card may comprise at least one antibody that specifically binds to an HLA isoform. An HLA isoform may be an HLA-A, HLA-B, HLA-C, HLA-DRB1, HLA-DRB3, HLA-DRB4, HLA-DRB5, HLA-DQA1, HLA-DQB1, HLA-DPA1, or HLA-DPB1 isoform. A test card may comprise antibodies that specifically bind to at least one HLA-A isoform, at least one HLA-B isoform, at least one HLA-C isoform, and/or at least one HLA-DRB1 isoform. A test card may comprise antibodies that specifically bind to two different HLA-A isoforms, two different HLA-B isoforms, two different HLA-C isoforms, and two different HLA-DRB1 isoforms. A test card may comprise antibodies that specifically bind to at least two different HLA-A isoforms, at least two different HLA-B isoforms, at least two different HLA-C isoforms, and/or at least two different HLA-DRB1 isoforms. A test card may comprise antibodies that specifically bind to at least 1, 2, 3, 4, 5, 6, 7, 8, 9, 10, 11, 12, 13, 14, 15, 16, 17, 18, 19, 20, 21, 22, 23, 24, 25, 30, 35, 36, 40, 48, 50, 60, 64, 70, 75, 80, 90, 96, or 100 different HLA isoforms selected from HLA-A, HLA-B, HLA-C, and HLA-DRB1. A test card may comprise antibodies that specifically bind to at least 1, 2, 3, 4, 5, 6, 7, 8, 9, 10, 11, 12, 13, 14, 15, 16, 17, 18, 19, 20, 21, 22, 23, 24, 25, 30, 35, 36, 40, 48, 50, 60, 64, 70, 75, 80, 90, 96, or 100 different HLA isoforms selected from HLA-A, HLA-B, HLA-C, HLA-DRB1, HLA-DRB3, HLA-DRB4, HLA-DRB5, HLA-DQA1, HLA-DQB1, HLA-DPA1, and HLA-DPB1.

A method may comprise identifying at least one HLA isoform, such as at least 1, 2, 3, 4, 5, 6, 7, or 8 different HLA isoforms, or a lack thereof. A method may comprise identifying one or more of at least eight different HLA isoforms, or the lack of one or more of the at least eight different HLA isoforms, e.g., wherein the at least eight different HLA isoforms comprise two different HLA-A isoforms, two different HLA-B isoforms, two different HLA-C isoforms, and two different HLA-DRB1 isoforms. A method may comprise identifying at least one HLA-A isoform, at least one HLA-B isoform, at least one HLA-C isoform, and/or at least one HLA-DRB1 isoform, or a lack of one or more of the foregoing. A method may comprise identifying two different HLA-A isoforms, two different HLA-B isoforms, two different HLA-C isoforms, and two different HLA-DRB1 isoforms, or a lack of one or more of the foregoing. A method may comprise identifying (i) zero to two different HLA-A isoforms, zero to two different HLA-B isoforms, zero to two different HLA-C isoforms, and zero to two different HLA-DRB1 isoforms, and (ii) a lack of one to two different HLA-A isoforms, one to two different HLA-B isoforms, one to two different HLA-C isoforms, and one to two different HLA-DRB1 isoforms, i.e., for each HLA locus for which two isoforms were not identified. A method may comprise identifying at least two different HLA-A isoforms, at least two different HLA-B isoforms, at least two different HLA-C isoforms, and/or at least two different HLA-DRB1 isoforms, or a lack of one or more of the foregoing. A method may comprise identifying at least 1, 2, 3, 4, 5, 6, 7, 8, 9, 10, 11, 12, 13, 14, 15, 16, 17, 18, 19, 20, 21, 22, 23, 24, 25, 30, 35, 36, 40, 48, 50, 60, 64, 70, 75, 80, 90, 96, or 100 different HLA isoforms selected from HLA-A, HLA-B, HLA-C, and HLA-DRB1, or a lack of at least 1, 2, 3, 4, 5, 6, 7, 8, 9, 10, 11, 12, 13, 14, 15, 16, 17, 18, 19, 20, 21, 22, 23, 24, 25, 30, 35, 36, 40, 48, 50, 60, 64, 70, 75, 80, 90, 96, or 100 of the foregoing. A method may comprise identifying at least 1, 2, 3, 4, 5, 6, 7, 8, 9, 10, 11, 12, 13, 14, 15, 16, 17, 18, 19, 20, 21, 22, 23, 24, 25, 30, 35, 36, 40, 48, 50, 60, 64, 70, 75, 80, 90, 96, or 100 different HLA isoforms selected from HLA-A, HLA-B, HLA-C, HLA-DRB1, HLA-DRB3, HLA-DRB4, HLA-DRB5, HLA-DQA1, HLA-DQB1, HLA-DPA1, and HLA-DPB1, or a lack of at least 1, 2, 3, 4, 5, 6, 7, 8, 9, 10, 11, 12, 13, 14, 15, 16, 17, 18, 19, 20, 21, 22, 23, 24, 25, 30, 35, 36, 40, 48, 50, 60, 64, 70, 75, 80, 90, 96, or 100 of the foregoing.

A test card may comprise at least one antibody that specifically binds to a biomarker associated with either a hereditary disease or a communicable disease. A test card may comprise at least one antigen that specifically binds to an antibody associated with either a hereditary disease or a communicable disease. A test card may comprise at least 1, 2, 3, 4, 5, 6, 7, 8, 9, or 10 different antibodies that specifically bind to different biomarkers associated with different hereditary diseases or different communicable diseases. A test card may comprise at least 1, 2, 3, 4, 5, 6, 7, 8, 9, or 10 different antigens that specifically bind to antibodies associated with different hereditary diseases or different communicable diseases. A hereditary disease may be, for example, 22q11.2 deletion syndrome, Angelman syndrome, Canavan disease, Charcot-Marie-Tooth disease, Color blindness, Cri du chat, Cystic fibrosis, Down syndrome, Duchenne muscular dystrophy, Haemochromatosis, Haemophilia, Klinefelter syndrome, Neurofibromatosis, Phenylketonuria, Polycystic kidney disease, Prader-Willi syndrome, Sickle-cell disease, Spinal muscular atrophy, Tay-Sachs disease, or Turner syndrome. A communicable disease may be, for example, hepatitis (e.g., hepatitis B or hepatitis C), HIV, or tuberculosis.

A method may comprise identifying at least one biomarker associated with a hereditary disease or a communicable disease, or a lack of a biomarker of the at least one biomarker. A method may comprise identifying at least one antibody associated with a hereditary disease or a communicable disease, or a lack of a biomarker of the at least one biomarker. A method may comprise identifying at least one biomarker associated with a hereditary disease or a communicable disease, or a lack of a hereditary disease or a communicable disease. A method may comprise identifying at least one antibody associated with a hereditary disease or a communicable disease, or a lack of a hereditary disease or a communicable disease.

Different regions of a test card may comprise different antibodies. A first region of a test card may comprise an anti-A antibody. A second region of a test card may comprise an anti-B antibody. A third region of a test card may comprise an anti-Rh antibody. A fourth region of a test card may comprise a control antibody. A region of a test card may comprise a graphical and/or alphanumeric identifier, e.g., to enable a system to identify a blood type. For example, a test card may comprise a region comprising an anti-A antibody, and the region may comprise a graphical or alphanumeric identifier that identifies the region (e.g., “Anti-A”). A test card may comprise a region comprising an anti-B antibody, and the region may comprise a graphical or alphanumeric identifier that identifies the region (e.g., “Anti-B”). A test card may comprise a region comprising an anti-Rh antibody, and the region may comprise a graphical or alphanumeric identifier that identifies the region (e.g., “Anti-D”). A test card may comprise a region comprising a control antibody, and the region may comprise a graphical or alphanumeric identifier that identifies the region (e.g., “Control”).

Different regions of a test card may comprise different antibodies that specifically bind to different HLA isoforms. Different regions of a test card may comprise different antibodies that specifically bind to different biomarkers, e.g., wherein each biomarker is associated with a hereditary disease or a communicable disease. Different regions of a test card may comprise different antigens that specifically bind to different antibodies, e.g., wherein each antigen is associated with a hereditary disease or a communicable disease.

A test card may comprise a barcode or matrix code. A graphical identifier may be a barcode or matrix code.

A test card may be a card (see, e.g., U.S. Pat. No. 2,770,572; hereby incorporated by reference in its entirety). A test card may be a strip, paper, gel, column, plate (e.g., a multi-well plate), or test tube (see, e.g., U.S. Pat. No. 6,955,889, hereby incorporated by reference in its entirety). The nature of a test card is not particularly limiting so long as the test card may be used to assay blood or a blood component.

A diagnostic device may comprise a test card. For example, a diagnostic device may comprise a housing and a test card disposed within the housing. Thus an image of a test card may be an image of a diagnostic device comprising a test card.

A method may comprise contacting a test card with blood, such as whole blood. A method may comprise contacting a test card with a blood component, such as erythrocytes. The blood or blood component may be from a single subject. A human user may contact a test card with blood or a blood component, e.g., contacting a test card with blood may be a step that is not a computer-implemented step.

A test card may comprise blood, such as whole blood, e.g., after contacting the test card with blood. A test card may comprise a blood component, such as erythrocytes, e.g., after contacting the test card with the blood component.

### III. Character and Image Recognition

A first image may comprise and image of a test card, wherein the test card comprises text (e.g., an alphanumeric identifier) and/or graphical identifiers. A first image may comprise text and/or graphical identifiers. A first image may comprise a barcode or matrix code. Text, a graphical identifier, a barcode, and/or a matrix code may comprise information related to a blood type or information about a subject.

A method may comprise character recognition of text in a first image (e.g., optical character recognition), wherein the character recognition is performed by the computer. A method may comprise reading a barcode or matrix code in a first image, e.g., wherein reading a barcode or matrix code is performed by a computer.

Text, a graphical identifier, a barcode, and/or a matrix code may comprise information about a test card and/or information about a source of blood (e.g., which identifies the subject from whom the blood was obtained). Thus, a computer may be configured to identify information about a test card and/or information about a source of blood, for example, by recognizing or reading one or more of text, graphical identifier(s), barcode(s), and/or matrix code(s) in a first image. A method may comprise identifying information about a test card and/or information about a source of blood, e.g., by recognizing or reading one or more of text, graphical identifier(s), barcode(s), and/or matrix code(s) in a first image.

Information related to a blood type and information about a subject may comprise a date that the blood of the subject was drawn, a date that the blood (or a component thereof) was contacted to a test card, the name of the subject, an identifier for the subject (such as an alphanumeric identifier, barcode, or matrix code), and/or an identifier for the test card (such as an alphanumeric identifier, barcode, or matrix code).

In some embodiments, the first image comprises text and the text comprises sufficient information to identify a blood type. For example, a first image may comprise text that states what the blood type of a subject is. Such images include an image of the medical records of a subject or a note made by a medical professional, such as a phlebotomist.

A first image may comprise text and comprise sufficient information to identify a blood type, but the text alone may comprise insufficient information to identify the blood type. For example, a first image may comprise an image of a test card, the first image may comprise sufficient information to identify a blood type, the test card may comprise text, and yet the text alone may comprise insufficient information to identify the blood type, i.e., because the text and blood patterns are both necessary and sufficient to identify the blood type.

IV. Displaying Content Related to a Blood Type and/or Real-Time Images

A method may comprise displaying a second image. A second image may comprise a real-time image and/or content related to a blood type. A second image may comprise computer-generated graphics or computer-generated text.

A real-time image refers to an actual image of the real world, e.g., as obtained by a camera or as viewed through a screen. A real time image may be a live, direct image or a live, indirect image of a real-world environment. A real-time image may be updated with time to reflect a present or near-present state. A live video feed is an example of a real-time image. A real-time image may be displayed as it is obtained and processed. A real-time image may be delayed (e.g., by 1 ms to 10 s). A real-time image may be substantially free from delay. A real-time image may refresh periodically, such as once every millisecond to once every ten seconds.

Content may comprise computer-generated graphics or computer-generated text, e.g., related to a blood type. Content may comprise a virtual image, e.g., an image that does not presently exist in the real world.

A second image may comprise a real-time image and content. A real-time image and content may be layered, e.g., such that the content is superimposed on the real-time image. A second image may be an augmented reality image. Methods for overlaying images in augmented reality displays are known, and include Layar (Blippar, London), Word Lens (Quest Visual, Inc., San Francisco), and Wikitude (Wikitude GmbH, Austria), see, e.g., US 2011/0090253, WO 2011/151422, and WO 2013/011121, each of which is hereby incorporated by reference in its entirety.

The real-time image and content may be displayed separately or in proximity, e.g., on the same display.

Content may comprise one or more of a blood type; information about a subject with whom the blood type is associated; information about the prevalence and/or location of blood or blood plasma that is compatible with the subject; information about the prevalence and/or location of one or more blood donors or blood plasma donors who are compatible with the subject; and information about the prevalence and/or location of one or more recipients who are compatible with the blood or blood plasma of the subject. The term “location content,” as used herein, may refer to information about the proximity and/or location of blood or blood plasma that is compatible with the subject; information about the proximity and/or location of one or more blood donors or blood plasma donors who are compatible with the subject; and information about the proximity and/or location of one or more recipients who are compatible with the blood or blood plasma of the subject. The term “blood-type content,” as used herein, may refer to a blood type or information about a subject with whom the blood type is associated.

Content may comprise one or more of an HLA type; information about a subject with whom the HLA type is associated; information about the prevalence and/or location of tissue, bone marrow, and/or organ(s) that are compatible with the subject; information about the prevalence and/or location of one or more tissue, bone marrow, and/or organ donors who are compatible with the subject; and information about the prevalence and/or location of one or more recipients who are compatible with the tissue, bone marrow, and/or organs of the subject. The term “location content,” as used herein, may refer to information about the proximity and/or location of tissue, bone marrow, and/or organ(s) that are compatible with the subject; information about the proximity and/or location of one or more tissue, bone marrow, and/or organ donors who are compatible with the subject; and information about the proximity and/or location of one or more recipients who are compatible with the tissue, bone marrow, and/or organs of the subject. The term “blood-type content,” as used herein, may refer to an HLA type or information about a subject with whom the HLA type is associated.

Content may comprise information about one or more hereditary diseases or communicable diseases that are associated with a first image or not associated with a first image. Content may comprise information about one or more hereditary diseases or communicable diseases that are associated with a blood sample or not associated with the blood sample. Content may comprise information about one or more hereditary diseases or communicable diseases that are associated with a subject or not associated with the subject.

A method may comprise obtaining a first image, and the first image may be the real time image. For example, a method may comprise obtaining a first image, wherein the first image comprises an image of a test card, and the first image is the real-time image. A method may comprise displaying a second image comprising the real-time image and content, wherein the content comprises information related to a blood type that may not be explicitly presented in the first image. The method may thereby interpret a test card to display a blood type.

A method may comprise displaying a second image comprising a real-time image and content, wherein the content comprises (a) information about the prevalence and/or location of blood or blood plasma that is compatible with the subject and/or (b) information about the prevalence and/or location of one or more blood donors or blood plasma donors who are compatible with the subject. A location may be a blood bank, hospital, surgical center, other medical facility, medical research facility, other research facility, or medical school, or a room, blood storage area, or blood-product storage area of any one of the foregoing. The content may comprise directions to a location. The content may comprise a distance to a location. The content may comprise the identity of the blood or blood plasma at a location. The content may comprise the identify of a blood donor or blood plasma donor at a location.

A method may comprise displaying a second image comprising a real-time image and content, wherein the content comprises information about the prevalence and/or location of one or more recipients who are compatible with the blood or blood plasma of the subject. A location may be a blood bank, hospital, surgical center, other medical facility, medical research facility, other research facility, or medical school, or a room, blood storage area, or blood-product storage area of any one of the foregoing. The content may comprise directions to a location. The content may comprise a distance to a location. The content may comprise the identity of a recipient at a location.

In some embodiments, the second image does not comprise a real-time image. For example, the second image may comprise a stored image of a test card and blood-type content, or the second image may comprise a map and location content.

A method may comprise displaying a map. A second image may consist of a map. A second image may comprise a map. For example, a second image may comprise a real-time image and content, wherein the content comprises a map and the map is superimposed on the real-time image. A map may be a three-dimensional representation, e.g., that rotates in sync with rotations of the display.

### V. Systems

In some aspects, the invention relates to a system comprising a computer and a display. A system may further comprise a camera. A system may be a laptop computer, desktop computer, tablet computer, or smartphone. A system may comprise a laptop computer, desktop computer, tablet computer, or smartphone. A system may be or a system may comprise a wearable computer, such as an augmented reality wearable computer or wearable augmented reality device. A system may be configured to implement a method as described herein. A system may be configured to implement one or more steps of a method as described herein.

A computer may be the computer of a laptop computer, desktop computer, tablet computer, smartphone, wearable computer, or wearable augmented reality device. The nature of the computer is not particularly limiting. For example, a computer may be the computer of a web-server. A camera may be a camera of a laptop computer, desktop computer, tablet computer, smartphone, wearable computer, or wearable augmented reality device. The nature of the camera is not particularly limiting, however, so long as the camera is configured to transmit an image to the computer. A display may be a display of a laptop computer, desktop computer, tablet computer, wearable computer, or wearable augmented reality device. The nature of the display is not particularly limiting, however, so long as the display is configured to receive images from the computer.

A “computer” may comprise more than one computer, e.g., a first computer configured to (a) receive a first image, (b) determine whether the first image comprises information related to a blood type, and (c) identify the blood type, and a second computer configured to transmit a second image to a display.

A first communication interface may connect a camera to a computer. A second communication interface may connect a display to a computer.

A first communication interface and/or second communication interface may comprise a wired communication interface. Wired communication interfaces include physical connections comprising a medium that conducts electricity, such as a wire, or a medium that carries light, such as an optical fiber. A laptop computer, desktop computer, tablet computer, or smartphone may comprise wired communication interfaces that connect a camera and/or a display to a computer, e.g., by utilizing a combination of conductive tracts on one or more printed circuit boards and wiring. A wired communication interface may comprise, for example, a USB connection, Ethernet connection, or FireWire connection.

A first communication interface and/or second communication interface may comprise a wireless communication interface. Wireless communication interfaces include, for example, Wi-Fi, Bluetooth, ZigBee, and cellular connections.

A camera may be configured to receive instructions from a computer to obtain an image. A camera may be configured to obtain a first image. A camera may be configured to transmit a first image to a computer. A camera may be configured to receive instructions from a computer to obtain a real-time image. A camera may be configured to obtain a real-time image. A camera may be configured to transmit a real-time image to a computer.

A computer may be configured to send instructions to a camera to obtain an image. A computer may be configured to receive a first image from a camera. A computer may be configured to send instructions to a camera to obtain a real-time image. A computer may be configured to receive a real-time image from a camera.

A computer may comprise software for identifying a blood type based on an image of a test card. A computer may be configured to determine whether a first image comprises information related to a blood type. A computer may be configured to determine whether a first image comprises a test card. Determining whether a first image comprises information related to a blood type or whether a first image comprises a test card may or may not comprise receiving an input (e.g., a user input) indicating whether the first image comprises information related to a blood type or whether a first image comprises a test card. For example, a user may select a software application for imaging a test card, or a user may identify a first image as an image of a test card.

A computer may comprise software configured to identify blood patterns on a test card, e.g., and associate one or more blood patterns with a blood type. A computer may be configured to identify blood patterns on a test card, e.g., and associate one or more blood patterns with a blood type.

A computer may be configured to recognize text, e.g., in a first image. A computer may comprise software for character recognition (e.g., optical character recognition). A computer may be configured to determine whether text comprises sufficient information to identify a blood type. A computer may be configured to read a barcode and/or matrix code, e.g., in a first image. A computer may be configured to identify a blood type, e.g., based on a first image.

A computer may be configured to transmit a first image to an external computer and receive content from the external computer, thereby (a) determining whether the first image comprises information related to a blood type, (b) identifying the blood type, and/or (c) generating content. An external computer may or may not be part of a system as described herein. The computer may be, for example, a computer of a laptop computer, desktop computer, tablet computer, smartphone, wearable computer, or wearable augmented reality device, and the external computer may be a computer of a web server.

A computer may be configured to generate a second image comprising a real-time image and content. A computer may be configured to generate a second image comprising a stored image of a test card and content. A computer may be configured to generate a second image comprising a map and location content.

A computer may comprise software for transmitting content to a display. A computer may be configured to transmit a second image to a display. A display may be configured to display the second image. A display may be configured to display a real-time image.

### VI. Subjects

A subject may be a human subject. A subject may be selected from rodents, lagomorphs, felines, canines, porcines, ovines, bovines, equines, and primates. A subject may benefit from a blood transfusion. A subject may have blood loss. A subject may have hypovolemia. A subject may be hypotensive. A subject may have hemorrhagic shock. A subject may require surgery that may require a blood transfusion. A subject may be at risk for blood loss. A subject may have hemophilia. A subject may be a pregnant woman, such as a pregnant woman in labor. A subject may be a blood donor. A subject may be a tissue, bone marrow, or organ donor. A subject may be in need of a tissue, bone marrow, or organ donation. A subject may be healthy, such as a healthy, human adult.

### EXEMPLIFICATION

### Example 1

### Method for Analyzing Blood

A user fills out a test card with the name of a subject and the date. The user draws blood from the subject. The user contacts blood to an anti-A antibody, an anti-B antibody, an anti-Rh antibody, and a control antibody on the test card. The test card comprises printed text that identifies each antibody. The user obtains a first image of the test card using a digital camera of a tablet computer or smartphone. The first image is optionally video.

The tablet computer or smartphone transmits the first image to an external computer. The external computer performs optical character recognition of the text in the first image. The external computer identifies that the first image is an image comprising a test card. The external computer optionally identifies the name of the subject and the date on the test card. The external computer optionally constructs a 3-dimensional image of the test card from video (e.g., the blood patterns on the test card). The external computer identifies the blood type of the blood on the test card. The external computer creates blood-type content comprising text that identifies the blood type.

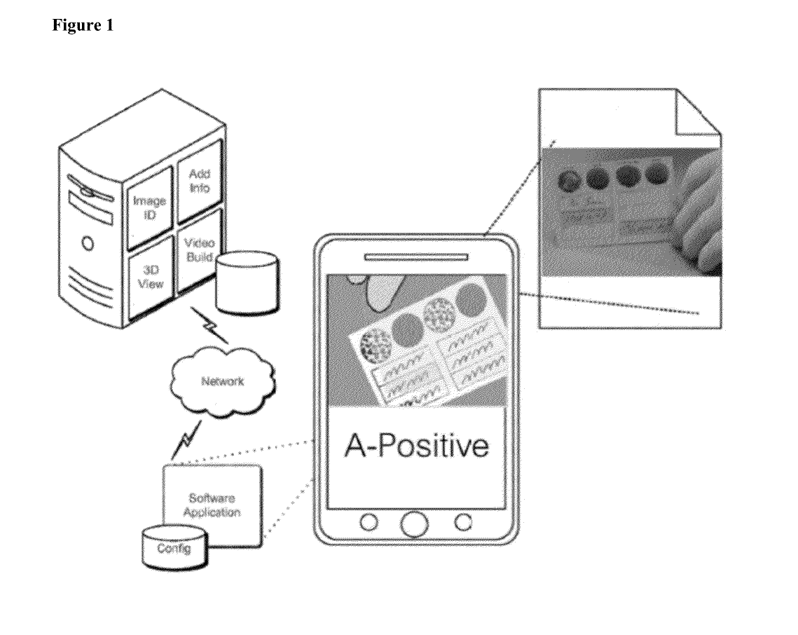

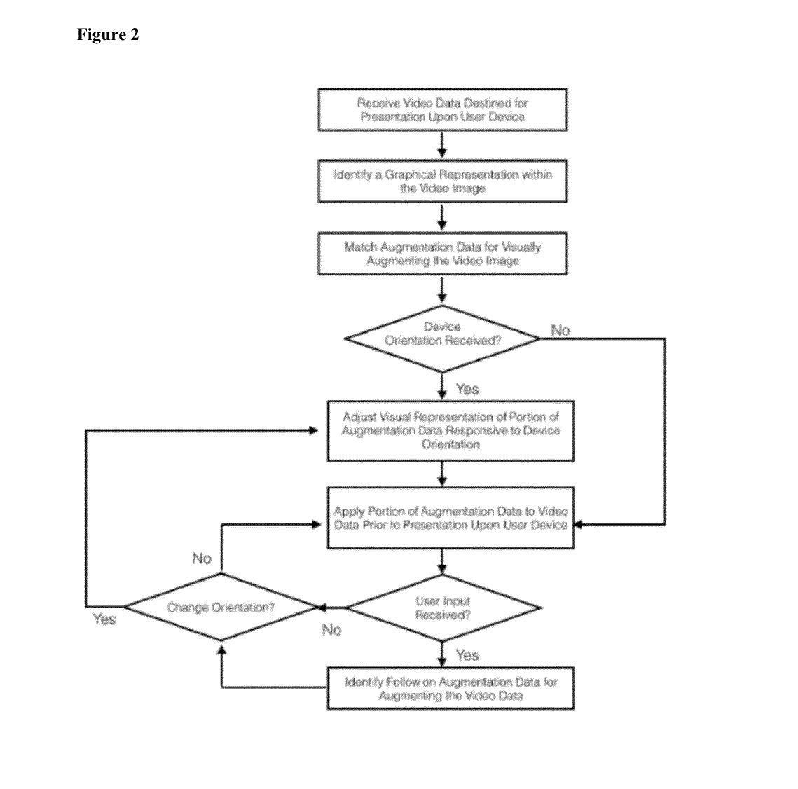

The external computer transmits the blood-type content to the tablet computer or smartphone. The tablet computer or smartphone displays a second image comprising the test card and the blood-type content. The second image optionally comprises a real-time image of the test card (FIG. 1). The tablet computer or smartphone optionally adjusts the position of the blood-type content on the display relative to a real-time image of the test card (FIG. 2).

### Example 2

### Location of Blood, Blood Plasma, and/or a Donor or Recipient Thereof

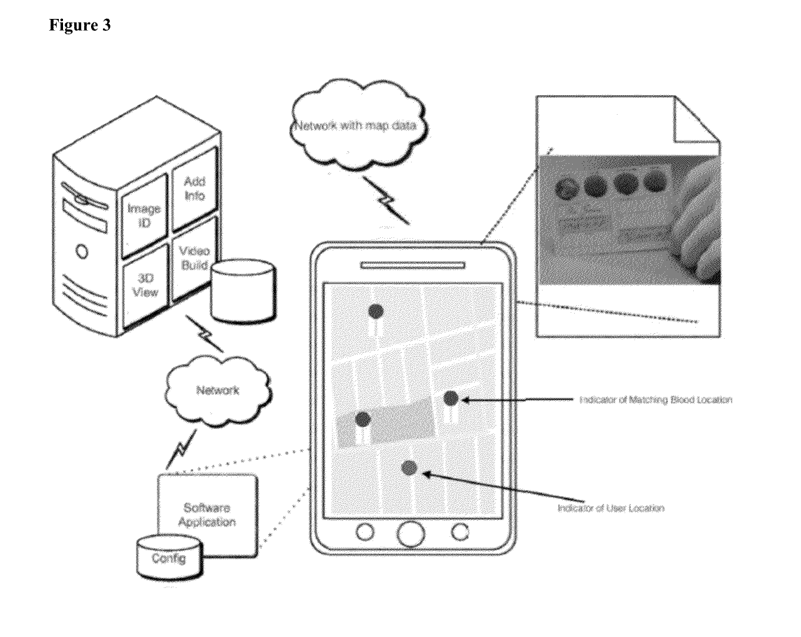

The external computer of Example 1 identifies the location of blood, blood plasma, one or more blood donors, one or more blood plasma donors, one or more blood recipients, and/or one or more blood plasma recipients. The external computer creates location content comprising each location. The external computer transmits the content to the tablet computer or smartphone. The tablet computer or smartphone either comprises stored map content or receives map content from the external computer or another external device (such as a web server). The tablet computer or smartphone displays a third image comprising a map and the location content (FIG. 3).

### Example 3

### Integrated Content

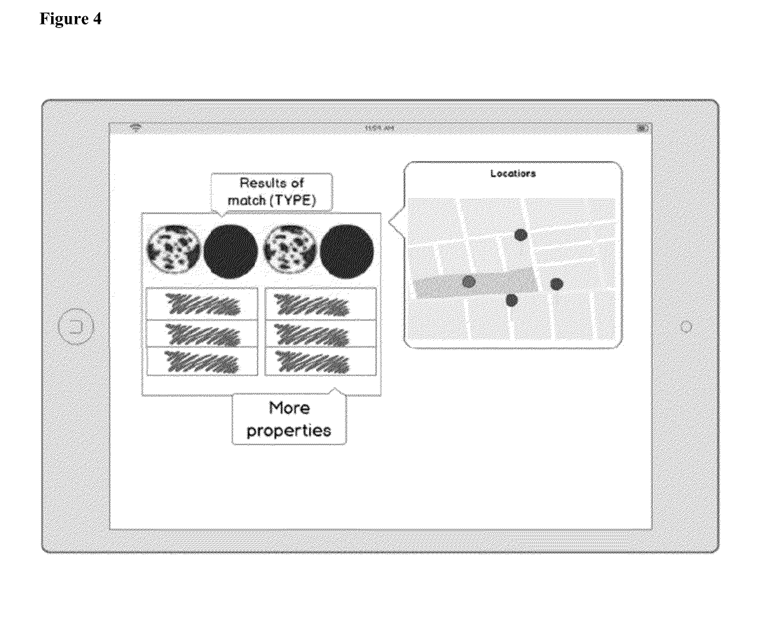

The tablet computer or smartphone of Example 2 displays both the blood-type content and the location content (FIG. 4). The table computer optionally displays an image of the test card, e.g., a real-time image of the test card or a stored image of the test card.

### INCORPORATION BY REFERENCE

All of the patents, patent application publications, and other references cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

1. A method for analyzing blood, comprising:
determining whether a first image comprises an image of a blood test card; and
if the first image comprises an image of a blood test card:
(i) identifying the blood type; and
(ii) displaying a second image,
wherein:
determining whether the first image comprises an image of a blood test card; identifying the blood type; and displaying a second image are computer-implemented steps;
the second image comprises content related to the blood type;
the content comprises computer-generated graphics or computer-generated text; and
the content comprises one or more of: the blood type; information about a subject with whom the blood type is associated; information about the prevalence and/or location of blood or blood plasma that is compatible with the subject; information about the prevalence and/or location of one or more blood donors or blood plasma donors who are compatible with the subject; and information about the prevalence and/or location of one or more recipients who are compatible with the blood or blood plasma of the subject.

2. The method of claim 1, wherein:
the first image comprises an image of a test card;
the test card comprises one or more antibodies;
the one or more antibodies are selected from the group consisting of an anti-A antibody, an anti-B antibody, and an anti-Rh antibody; and
the test card comprises erythrocytes of the blood.

3. The method of claim 2, wherein the one or more antibodies comprise an anti-A antibody, an anti-B antibody, an anti-Rh antibody, and a control antibody.

4. The method of claim 2, further comprising contacting blood to the test card.

5. The method of claim 1, wherein the second image comprises a real-time image.

6. The method of claim 5, wherein:
the real-time image comprises an image of a test card;
the test card comprises an anti-A antibody, an anti-B antibody, and an anti-Rh antibody;
the test card comprises blood; and
the content comprises the blood type.

7. The method of claim 5, wherein the content comprises one or more of: information about the proximity and/or location of blood or blood plasma that is compatible with the subject;
information about the proximity and/or location of one or more blood donors or blood plasma donors who are compatible with the subject; and information about the proximity and/or location of one or more recipients who are compatible with the blood or blood plasma of the subject.

8. The method of claim 7, wherein the content further comprises directions to a location.

9. The method of claim 1, wherein the content comprises a map and one or more of:
information about the proximity and/or location of blood or blood plasma that is compatible with the subject; information about the proximity and/or location of one or more blood donors or blood plasma donors who are compatible with the subject; and information about the proximity and/or location of one or more recipients who are compatible with the blood or blood plasma of the subject.

10. The method of claim 1, wherein:
identifying a blood type comprises identifying one or more of at least eight different HLA isoforms, or the lack of one or more of the at least eight different HLA isoforms; and
the at least eight different HLA isoforms comprise two different HLA-A isoforms, two different HLA-B isoforms, two different HLA-C isoforms, and two different DRB 1 isoforms.

11. The method of claim 1, further comprising identifying a biomarker or an antibody that is associated with a hereditary disease or a communicable disease, or a lack of a hereditary disease or a communicable disease.

12. A system configured to implement the method of claim 1, comprising a computer and a display, wherein:
a communication interface connects the display to the computer;
the computer is configured to determine whether the first image comprises an image of a blood test card;
the computer is configured to identify the blood type;
the computer is configured to transmit the second image to the display; and
the display is configured to display the second image.

13. The system of claim 12, further comprising a camera, wherein:
the camera is configured to obtain the first image;
a communication interface connects the camera to the computer; and
the computer is configured to receive the first image from the camera.

14. A system for analyzing blood, comprising:
a computer;
a camera, wherein a first communication interface connects the camera to the computer; and
a display, wherein a second communication interface connects the display to the computer;
wherein:
the computer is configured to receive a first image from the camera;
the computer is configured to determine whether the first image comprises information related to a blood type,
the computer is configured to identify a blood type if the first image comprises information related to a blood type; and
the computer is configured to transmit a second image to the display, wherein the second image comprises content, and the content comprises one or more of: the blood type; information about the subject with whom the blood type is associated; information about the prevalence and/or location of blood or blood plasma that is compatible with the subject; information about the prevalence and/or location of one or more blood donors or blood plasma donors who are compatible with the subject; and information about the prevalence and/or location of one or more recipients who are compatible with the blood or blood plasma of the subject.

15. The system of claim 14, wherein the system is a laptop computer, desktop computer, tablet computer, smartphone, or wearable augmented reality device.

16. The system of claim 14, wherein the second image further comprises a real-time image from the camera.

17. A method for analyzing blood, comprising:
character recognition of text in a first image;
determining whether the text comprises sufficient information to identify a blood type; and
if the text comprises sufficient information to identify a blood type:
(i) identifying the blood type; and
(ii) displaying a second image,
wherein:
character recognition of the text; determining whether the text comprises sufficient information to identify a blood type; identifying the blood type; and displaying a second image are computer-implemented steps;
the second image comprises content related to the blood type;
the content comprises computer-generated graphics or computer-generated text; and
the content comprises one or more of: the blood type; information about a subject with whom the blood type is associated; information about the prevalence and/or location of blood or blood plasma that is compatible with the subject; information about the prevalence and/or location of one or more blood donors or blood plasma donors who are compatible with the subject; and information about the prevalence and/or location of one or more recipients who are compatible with the blood or blood plasma of the subject.

18. The method of claim 17, wherein the first image is an image of a medical record or a note made by a medical professional.

19. A system configured to implement the method of claim 17, comprising a computer and a display, wherein:
a communication interface connects the display to the computer;
the computer is configured to perform character recognition of text in the first image;
the computer is configured to determine whether the text comprises sufficient information to identify a blood type;
the computer is configured to identify the blood type;
the computer is configured to transmit the second image to the display; and
the display is configured to display the second image.

20. The system of claim 19, further comprising a camera, wherein:
the camera is configured to obtain the first image;
a communication interface connects the camera to the computer; and
the computer is configured to receive the first image from the camera.
